(19) United States
(12) Patent Application Publication
(10) Pub. No.: US 2022/0319353 A1
(43) Pub. Date: Oct. 6, 2022

(54) Big Rig Backup Courses

(71) Applicant: Antwalla Simple, Rosharon, TX (US)

(72) Inventor: Antwalla Simple, Rosharon, TX (US)

(21) Appl. No.: 17/499,832

(22) Filed: Oct. 12, 2021

Related U.S. Application Data
(60) Provisional application No. 63/198,308, filed on Apr. 2, 2021.

(51) Int. Cl. G09B 19/16

(52) U.S. Cl. CPC G09B 19/167; G09B 9/052

(57) ABSTRACT

The present invention comprises a tool and a method for use in CDL training. The tool comprises a flat plane segmented into sections designated as levels. Each level comprises a one or more parking lanes to support the designated level. The size of each level is customized to support the backup training level. The tool can further comprise a software application to provide simulated backup instruction for the user.

### BACKGROUND OF THE INVENTION

This application claims the benefit of provisional application 63/198,308.

The present invention relates to Commercial Motor Vehicle Driving Training (“CDL”) Course apparatus and method. Specifically, the present invention relates to an apparatus to be use in backup maneuvering during CDL Driving Training.

Today truck drivers have become an important career. It takes highly specialized knowledge and skills to operate a commercial motor vehicle (“CMV”). Prior to 1986, many states allowed anyone with an automobile driver license to operate a CMV. As a result, many drivers throughout the country were driving CMVs without proper training. In 1986 the Commercial Motor Vehicle Safety Act was signed into law which made it mandatory for all drivers of commercial vehicles to have a CDL. By ensuring that bus drivers and operators of large trucks are highly trained and qualified, this law has improved highway safety significantly.

Now, a Commercial Driver's License is required to drive commercial motor vehicles (CMVs) such as tractor-trailers, semi-trucks, dump trucks, and passenger buses. There are three classes of CDLs that determine the kinds of vehicles you're permitted to drive: Class A, Class B, and Class C.

A Class A commercial driver's license is required to operate any combination of vehicles with a gross combination weight rating (GVWR) of 26,001 or more pounds. With a Class A CDL a truck driver can drive the following types of vehicles: Tractor-trailers Truck and trailer combinations Tank vehicles Livestock carriers Flatbeds.

A Class B commercial driver's license is required to operate a single vehicle with a gross combination weight rating of 26,001 or more pounds, or tow a vehicle not heavier than 10,000 pounds. With a Class B CDL a truck driver can drive the following types of vehicles: Straight trucks Large passenger buses Segmented buses Box trucks Dump trucks with small trailers Tractor-trailers.

A Class C commercial driver's license is required to operate a vehicle that is designed to transport 16 or more occupants (including you, the driver) or transport hazardous materials (HazMat), materials that are classified as hazardous under federal law. With a Class C CDL a truck driver can drive the following types of vehicles: Small HazMat vehicles Passenger vans.

The CDL training course is designed to prepare a student to obtain a commercial driver's license (CDL), which is required for a career as a truck driver in the United States. During training, students are taught the necessary knowledge and skills to pass a series of tests to obtain their CDL. Such a program generally begins with classroom instruction geared towards passing the written exams for a CDL permit, a learner's permit that allows a student to practice driving skills on public roads with a CDL licensed driver or instructor. Students graduate from CDL training upon receiving their CDLs and proving that they can comfortably and safely drive and maneuver a truck. Most CDL training schools train drivers for a class A CDL, which allows the holder to drive a tractor trailer weighing over 26,000 pounds.

Although a CDL training course may provide you the basic, backup training is limited. The present invention provides a novel backup CDL driving course and a method of use of the aforementioned course.

### SUMMARY OF THE INVENTION

One objective of the present invention is to provide a cost-effective and safety training for CDL course.

Another objective of the present invention is to a tool to assist in the training of truck drivers.

The present invention comprises a tool and a method for use in CDL training. The tool comprises a flat plane segmented into sections designated as levels. Each level comprises a one or more parking lanes to support the designated level. The size of each level is customized to support the backup training level. The tool can further comprise a software application to provide simulated backup instruction for the user.

The size of each training level in the tool is defined by the number of parking lanes to support the parking level. The flat plane has a middle section comprising a rest area that is encircled by a roadway. In use the backend of the truck is placed at the front end of a designated parking lane.

The above and other objects, features and advantages of the present invention should become even more readily apparent to those skilled in the art upon a read in of the following detailed description in conjunction with the drawings wherein there is shown and described illustrative embodiments of the invention.

### BRIEF DESCRIPTION OF DRAWINGS

These and other details of the present invention will be described in connection with the accompanying drawings, which are not furnished only by way of illustration and not in limitation of the invention.

FIG. 1 is a perspective view of present invention, CDL Backup Training Course.

FIG. 2 is an exploded perspective view of alley docking depicted level 1 and 2 in FIG. 1.

FIG. 3 is an exploded perspective view of level 3, offset backing depicted in FIG. 1.

FIG. 4 is an exploded perspective view of level 4, sight side slanted backing depicted in FIG. 1.

FIG. 5 is an exploded perspective view of level 6, starting position of blind side parallel parking.

FIG. 6 is an exploded perspective view of level 6, entry position of blind side parallel parking.

FIG. 7 is an exploded perspective view of level 6, final position of blind side parallel parking

FIG. 8 is an exploded perspective view of level 6, starting position of sight side parallel parking.

FIG. 9 is an exploded perspective view of level 6, entry position of sight side parallel parking.

FIG. 10 is an exploded perspective view of level 6, final position of sight side parallel parking.

FIG. 11 is an exploded perspective view of level 8 of FIG. 1.

FIG. 12 is an exploded perspective view of level 9 of FIG. 1.

FIG. 13 is an exploded perspective view of level 5, difficult level of sight side Alley Dock backing depicted in FIG. 1.

FIG. 14 is an exploded perspective view of level 7, jack knife parked depicted in FIG. 1.

FIG. 15 is an exploded perspective view of level 8, blindside slanted backing depicted in FIG. 1 and level 9 blind side jack knife backing depicted in FIG. 1.

FIG. 16 is an exploded perspective view of level 9, jack knife parked depicted in FIG. 1.

FIG. 17 is an exploded perspective view of level 11, blind side jack knife backing depicted in FIG. 1.

### DETAILED DESCRIPTION OF THE INVENTION

The detailed description set forth below in connection with the appended drawings is intended as a description of the presently preferred embodiments of a portable beverage container and components thereof provided in accordance with aspects of the present devices, systems, and methods and is not intended to represent the only forms in which the present devices, systems, and methods may be constructed or utilized. The description sets forth the features and the steps for constructing and using the embodiments of the present devices, systems, and methods in connection with the illustrated embodiments. It is to be understood, however, that the same or equivalent functions and structures may be accomplished by different embodiments that are also intended to be encompassed within the spirit and scope of the present disclosure. As denoted elsewhere herein, like element numbers are intended to indicate like or similar elements or features.

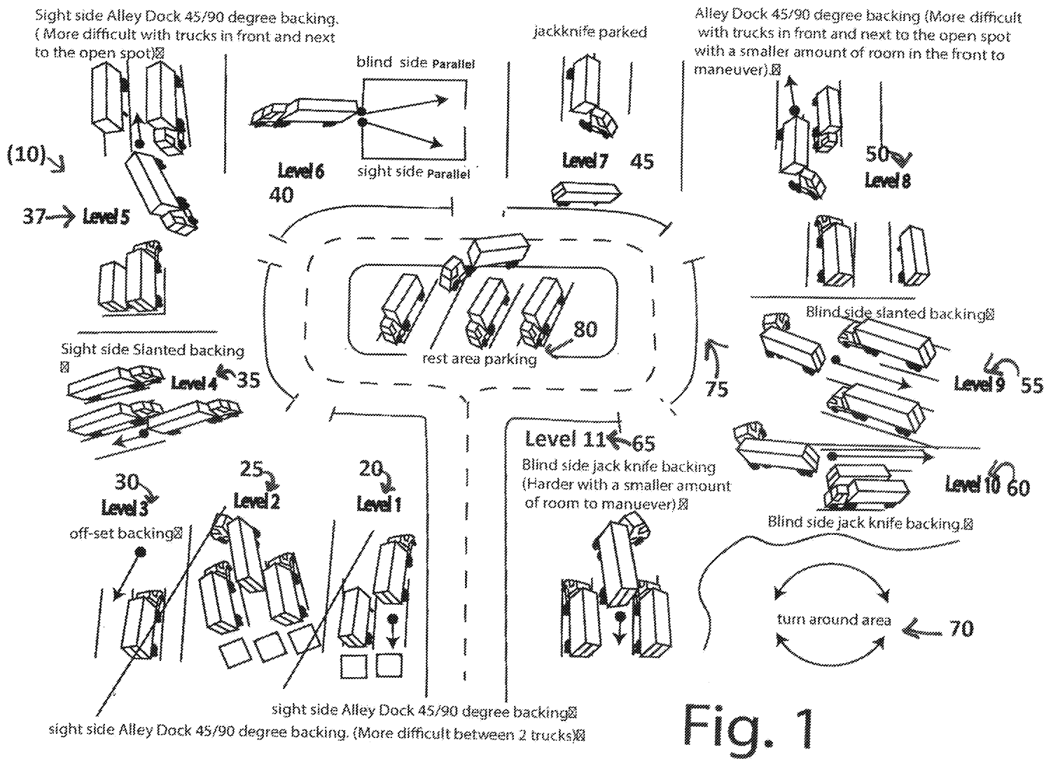

With reference now to FIG. 1, a backup driving course (10) in accordance with aspects of the present invention is shown. In an example, the backup driving course (10) comprises a flat surface area with a centrally disposed internal rest area surrounded by a plurality of parking levels. The flat surface area is made of asphalt, concrete or another suitable material.

The internal rest area comprises an oval shape section surrounded by a two-lane roadway. One or more parking lanes is disposed within the oval shape section. Each parking level has an entry/exit way into the internal rest area. Starting at the lower left area of the flat surface area is level one. Extending counterclockwise from level one and surrounding the internal rest area one is each designated level. In the illustrated embodiment there is 10 parking levels. However, the parking levels can be customized to support the CDL training facility.

Each parking level is defined by a pre-determined parking level space which has a rectangular shape defined by a top edge, bottom edge and opposing side edges. Within the pre-determined parking level space is plurality of parking lanes. The backup driving course can be manufactured to simulate one or more of the backup maneuvering levels.

This tool can also have a turnaround opened area (70) that is placed below level 11 and level 10. Additionally, linearly extended entry roadway (81) that perpendicularly aligns with the encircling roadway (82) the rest area. In use, a truck driver would enter into the extended roadway and drive around the encircling roadway (82) until an entry way to a selected training level is reached.

Each parking level depicted in FIG. 1 comprises a plurality of parking lanes configured to support a level of parking. Each parking level simulates real-world backup maneuvering conditions.

In the illustrated embodiment, each parking lane has a length of fifty feet and a width of sixty feet. Each level comprises a plurality of parking spaces configured to support a backup training maneuver. Additionally, to support realistic maneuvering, dummy trucks or trailers are placed in a parking lane to simulate real world conditions.

The following backup maneuvering levels can be supported by the backup training tool:

Alley Dock Backing—refers to backing at a 45 or 90 degree angle into the designated parking lane.

Straight Line Backing—refers to backing the truck in a straight line into the designated parking lane.

Parallel Parking—refers to parking in line with other vehicles parallel to simulated Curb A or Curb B.

Jackknife Backing—refers to the folding of a truck as it is backed in completely angle of folding knife and backing into the designated parking lane.

Sight Side Backing—refers to a driver backing from left driver side and has maximum visibility and backing into the designated parking lane.

Blindside Backing—refers to a driver backing toward the right side of the vehicle; driver has minimum visibility and backing into the designated parking lane.

FIG. 1 is an illustration of the preferred embodiment of the present invention and depicts the following parking levels in a counterclockwise position.

Level 1 (20) Alley Dock parking with two parking spaces.

Level 2 (25) Alley Dock Parking with three parking spaces.

Level 3 (30) Off Set parking with two parking spaces.

Level 4 (35) Sight side slanted parking with three slanted parking spaces.

Level 5 (37) Sight Side Alley Docking with three parking spaces directly across two parking spaces along with an opened space therebetween.

Level 6 (40) Simulated opposing curb sides.

Level 7 (45) Jackknifed parked with two parking spaces.

Level 8 (50) More Difficult Alley Dock backing with two parking spaces directly across three parking spaces with a smaller opened space therebetween.

Level 9 (55) blind side slanted backing with three slanted parking spaces.

Level 10 (60) blind side jackknife backing with three parallel parking spaces

Level 11 (65) blind side jack knife backing with three parallel parking spaces.

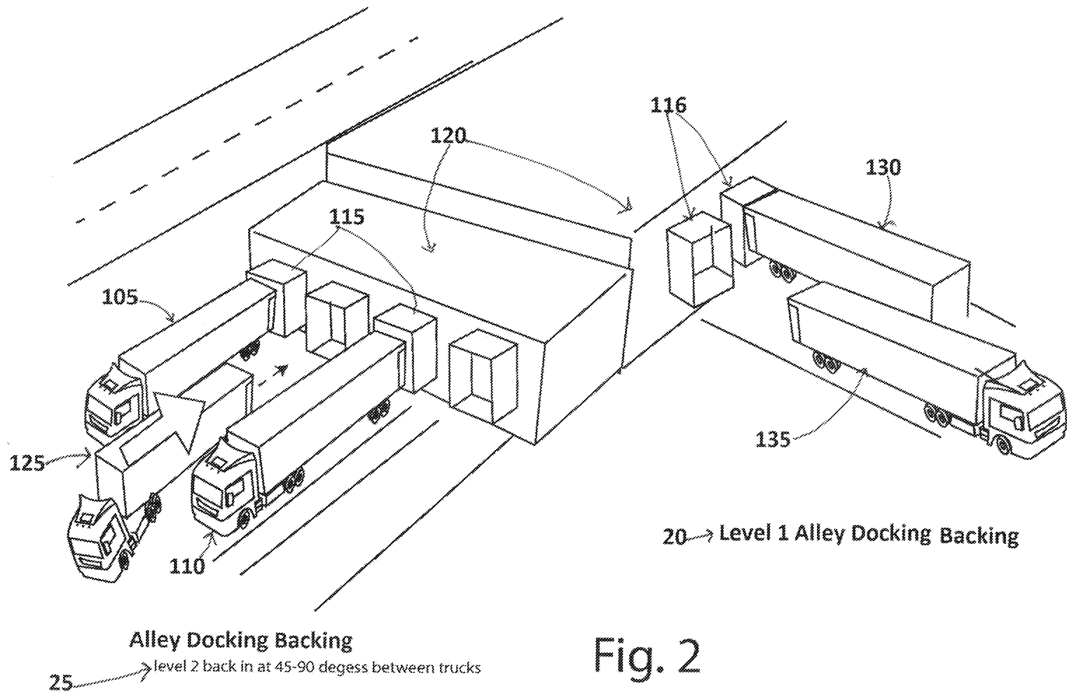

The Driving Course tool is used in combination with a commercial motor vehicle (“CMV”). In use, the CMV is placed in a backward position within a specific parking level with the distal end of the CMV facing inwardly to support backup driving within a specific level. As depicted in FIG. 2 to FIG. 17 the truck driver is situated in the position as designated in each figure and backup along the arrow as shown. Each maneuvering level depicted in FIG. 1 is further exploded in FIG. 2 to FIG. 17. Below each level is described.

Referring to FIG. 2, there is shown two levels of alley docking parking maneuvering. Level 1 (20) is alley dock backing where the back end of truck 135 is straight line backing maneuvered into docking opening 115. In Level 2 (25) in FIG. 2, the back end of truck 125 is manuvered at a 45 to 90 degree angle between truck 105 and truck 110 into dock openings 115 disposed in building structure 120.

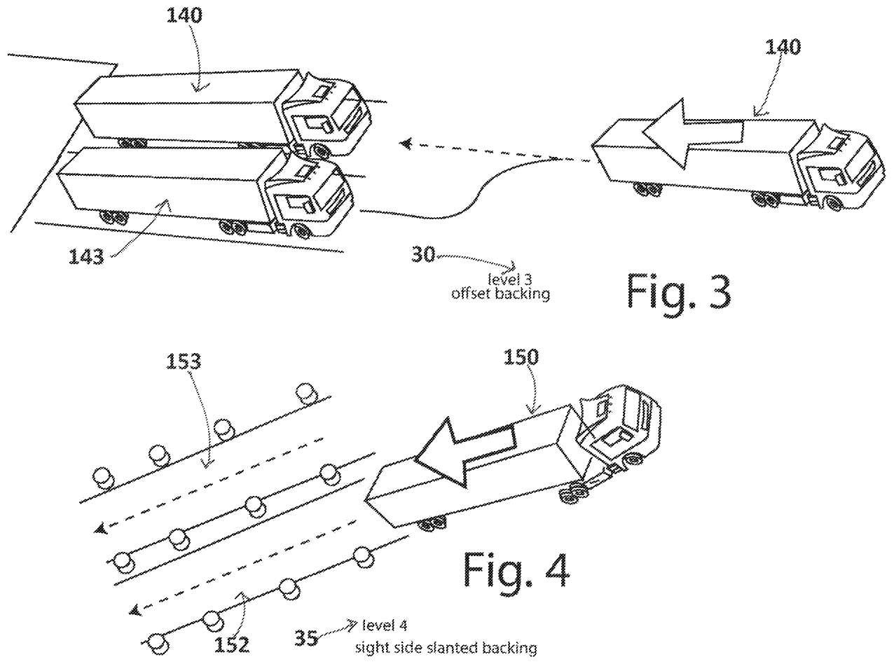

Referring to FIG. 3, there is show level 3 (30) offset backing wherein the back end of truck 140 is maneuvered straight into the parking space next to truck 143. Referring to FIG. 4, there is shown level 4 (35) sight side slanted backing wherein the back end of truck 150 is maneuvered into slanted park space 152. As depicted the truck driver maneuvers truck 150 from the driver side into parking space 152.

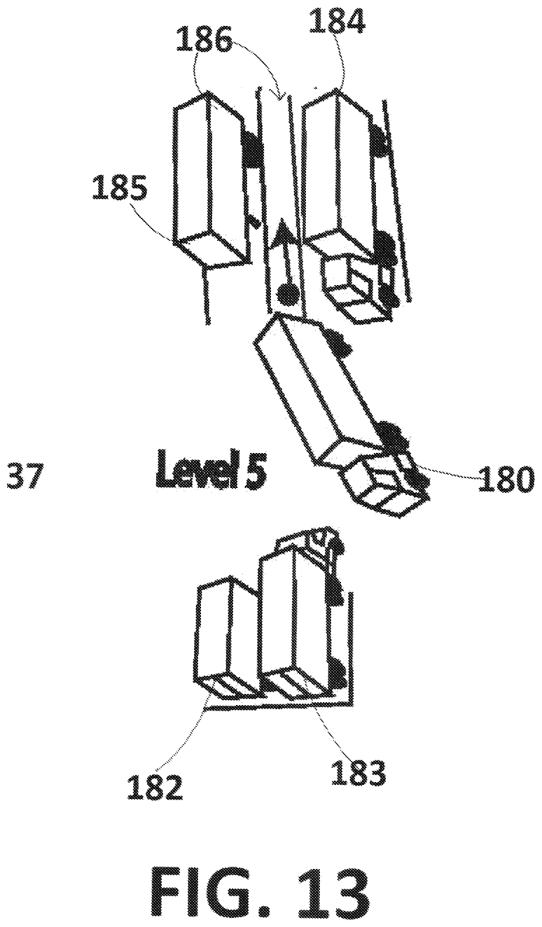

Referring to FIG. 13, there is shown an exploded view of level 5 (37). At this level, a truck (180) is located within an opened area between the top parking area and the bottom parking area. Located at the top parking area is simulated trucks 186 and 187 in a parallel arrangement. Parking space 186 is disposed between parking space 186 and 187. Simulated truck 183 and simulated trailer 182 are in the bottom parking area in a parallel arrangement. The back end of the truck (180) is moved between the two trucks (184 and 186) within the top parking area.

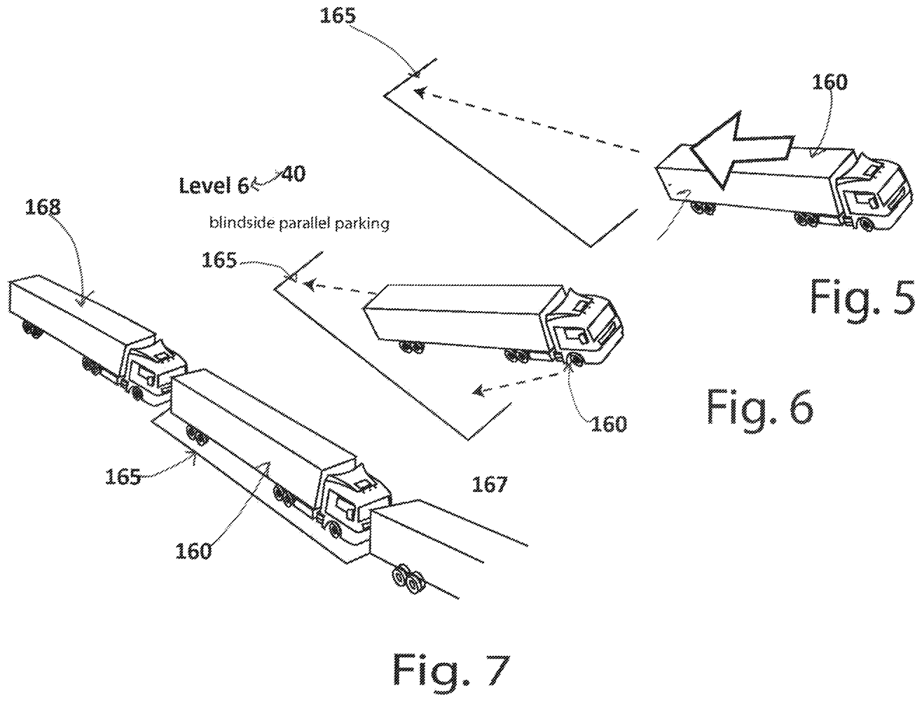

Referring to FIGS. 5, 6, and 7 there is shown simulated blind side parallel parking. Referring to FIG. 5, there is shown the entry position of the back end of truck 160. FIG. 6 illustrated truck 160 entering into the parallel parking space 165, and FIG. 7 illustrates truck 160 within parking space 165.

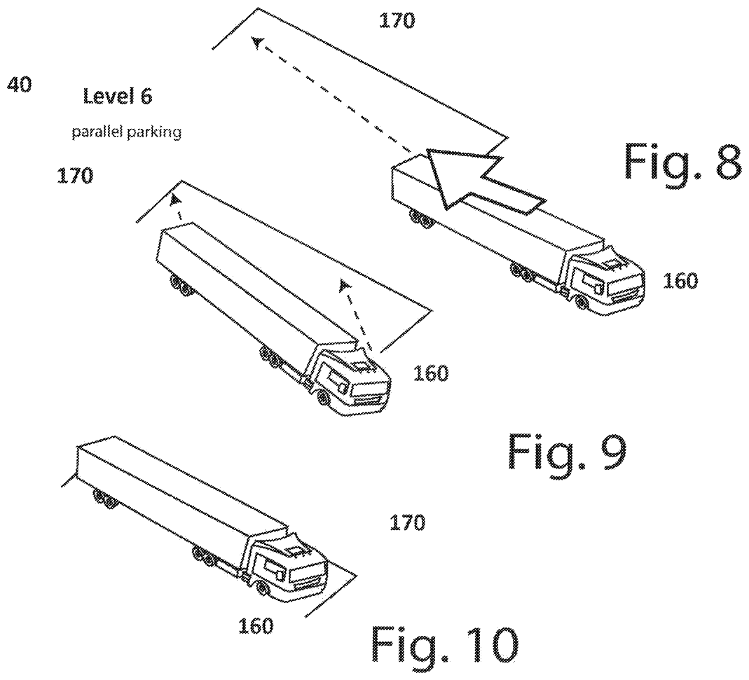

Referring to FIGS. 8, 9, and 10 there is shown simulated sight side parallel parking. Referring to FIG. 8 there is shown the entry position of the back end of truck 160. FIG. 9 illustrated truck 160 entering the parallel parking space 170 FIG. 10 illustrated truck 160 within parking space 170.

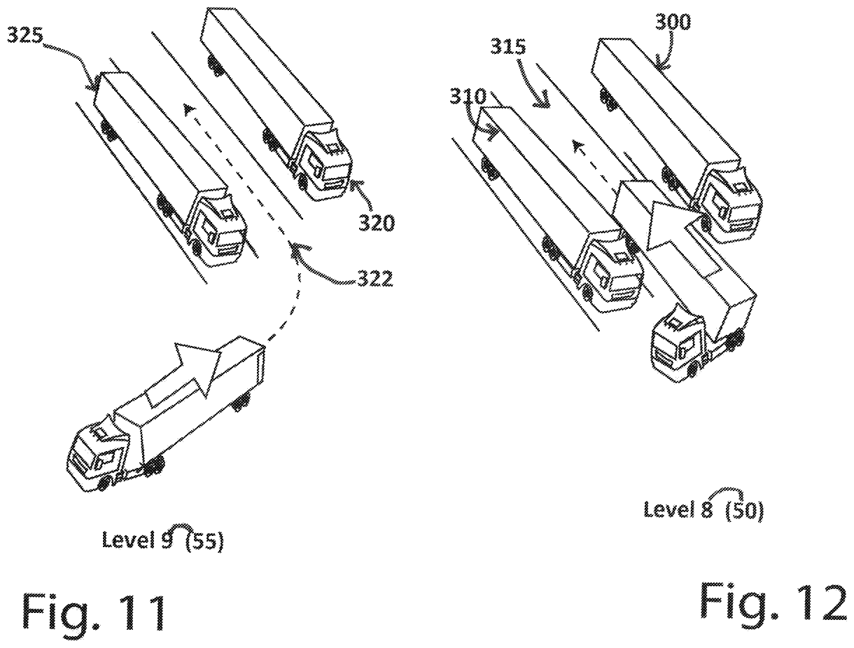

Referring to FIGS. 11 and 12 there is illustrated Blind Side slanted parking. FIG. 11 illustrates the back end of truck 322 being placed into a position to enter the parking space located between simulated truck 325 and 320. FIG. 12 illustrates the back end of truck 322 entering the parking space located between simulated truck 325 and 320

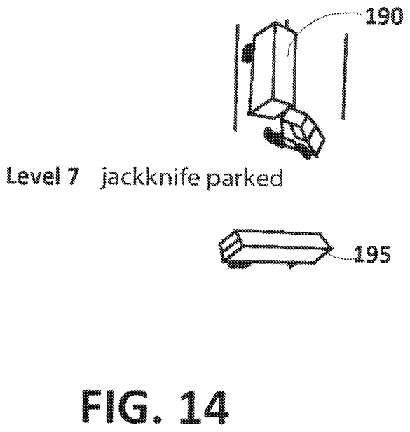

FIG. 14 illustrates truck 190 parked in a jackknife position behind simulated trailer 195.

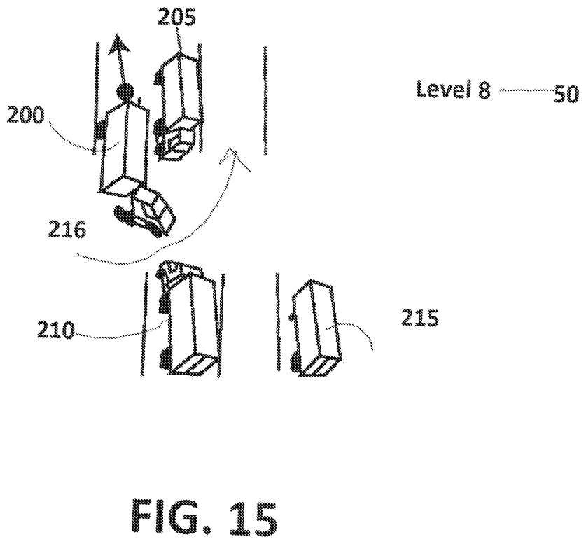

Referring to FIG. 15, there is shown level 8 (50). Depicted in this parking level are three parking spaces are located within the top parking area directly across three parking spaces located within the bottom parking area. As depicted truck 200 is backed into the parking space located next to truck 205. As shown the opened area in Level 8 (50) located between the top and bottom parking area is smaller than the opened area depicted at Level 5 in FIG. 13.

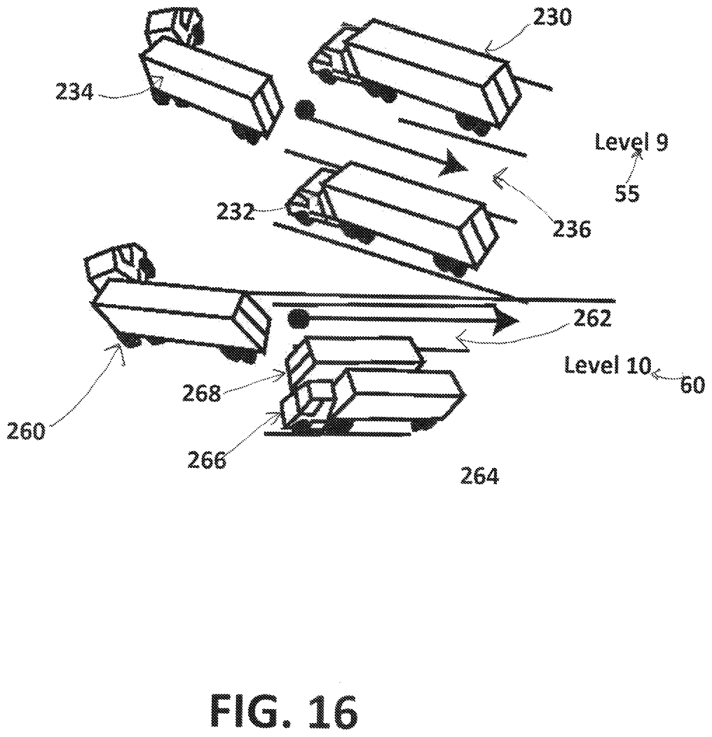

Referring to FIG. 16, there is shown Level 9 an exploded view of Level 9 (50), blindside slanted backing. As depicted the backend of truck 234 is backed within parking space 236 located between simulated truck 230 and 232. Depicted within Level 9 is three slanted parking spaces.

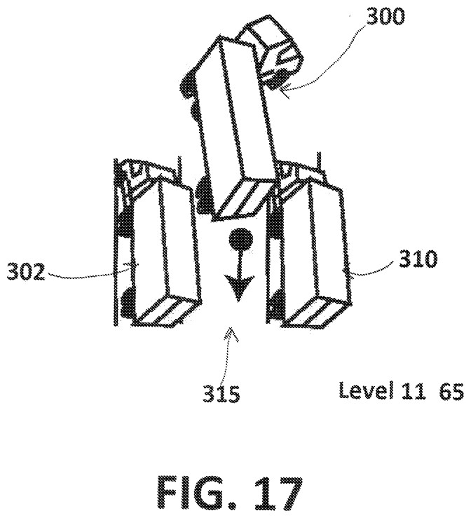

Referring to FIG. 16 there is shown an exploded view of level 10 (60). Depicted at this parking level blind side jackknife parking. This level has three parking spaces. Simulated trailer 268 and simulated truck 266 are placed in a parallel arrangement next to parking space 262. Truck 260 is placed in a jackknife position from the blind side as the truck 260 is placed into parking space 262. Referring to FIG. 17, there is shown level 11 (65), more difficult level of blind side jack knife backing. As depicted the back end of truck 300 is placed between simulated truck 302 and 310. This level has a smaller amount of room to maneuver than level 10.

Additionally, the entry way into a parking section can be manual or electronically.

A bar would be placed at the entry way. In the electronic version one or more sensors are placed on the bar such that when a car pulls up to the entry bar, the bar automatically opens. Alternatively, the bar would have to be manually opened and closed.

In alternative embodiment, the present invention further comprises a software application to provide simulated instruction. Additionally, the software can record the test drive on each level and provide the status and completion of each level of the course. The support software being stored a server in communication with the Application installed on a smart phone, tablet, computer or lap top browser. The Application browser provides the user the ability to connect to the server to register with the support software. The support software provides a module to register the user with the support software and create a customized training course by selecting from the levels depicted in FIG. 1. Once the user selects the training levels, the system creates a training module specifically containing contact information, registration authentication information, and selected training modules.

The system then provides the user the option to view simulated training instruction modules for the selected training levels depicted in FIG. 1. Each simulated training instruction module can be a video, or a computer simulated instruction module. After the user views the training instruction module. The system can provide the option to enter the actual simulated training module.

Once the user enters a selected training module from FIG. 1, each attempt is recorded by installed cameras or remotely viewed by installed camera. Each recorded view is stored in a database at the server based upon the user registration information. Alternatively, there may be an option where the recorded training session is mapped to the training instruction module to determine completion status.

What is claimed is:

1. A tool for backup training of a commercial vehicle comprising:
a flat plane field having a centrally located rest area section encircled by one or more simulated parking level sections;
each simulated parking level section having one or more parking spaces of a predetermined width and length; and
each simulated parking level section having a total number of the parking spaces.

2. The tool of claim 1 wherein the simulated parking level is selected from the group consisting of a simulated alley dock backing having 2 parking spaces, a simulated Alley Dock Backing with 3 parking spaces, a simulated sight side backing section having three parking spaces, simulated parallel parking section having opposing simulated curbsides for blindside and sight side backing, a simulated offset backing section with 2 parking spaces, a simulated sight side slanted backing section with three parking spaces, a simulated blind side slanted backing section with three parking spaces, and a simulated and jackknife parking section with two to three parking spaces.

3. The tool of claim 1 wherein a simulated trailer is disposed within one or more parking spaces to simulate a parking level section.

4. The tool of claim 1 wherein a simulated commercial vehicle is placed within one or more parking space to simulate a parking level section.

5. The tool of claim 1 further comprising an opened turn around section located at the lower right end of the flat plane field.

6. The tool of claim 1 wherein the flat plane field is made of material from the selected from the group of asphalt or concrete.

7. The tool of claim 1 wherein the rest area comprises one or more parking spaces.

8. The tool of claim 1 wherein the parking space have the pre-determined length of 50 feet;

9. The tool of claim 1 wherein the parking space have the pre-determined width of 60 feet.

10. A method of using the tool in claim 1 in combination with a commercial vehicle, the method comprising:
providing the tool in claim 1;
providing a commercial vehicle defined by a front end and a rear end;
placing the rear end of the commercial vehicle at a point in front of a designated parking space located within a simulated parking level section; and
backing the rear end into a designated space based upon a pre-defined simulated training.

11. The method of claim 10 wherein the pre-defined simulated training is is selected from the group consisting of a simulated alley dock backing having 2 parking spaces, a simulated Alley Dock Backing with 3 parking spaces, a simulated sight side backing section having three parking spaces, simulated parallel parking section having opposing simulated curbsides for blindside and sight side backing, a simulated offset backing section with 2 parking spaces, a simulated sight side slanted backing section with three parking spaces, a simulated blind side slanted backing section with three parking spaces, and a simulated and jackknife parking section with two to three parking spaces.
